(19) United States
(12) Patent Application Publication
(10) Pub. No.: US 2012/0068946 A1
(43) Pub. Date: Mar. 22, 2012

(54) TOUCH DISPLAY DEVICE AND CONTROL METHOD THEREOF

(76) Inventors: Sheng-Kai Tang, Taipei (TW); Kuo-Chung Chiu, Taipei (TW); Sheng-Ta Lin, Taipei (TW); Wen-Chieh Tseng, Taipei (TW)

(21) Appl. No.: 13/232,495

(22) Filed: Sep. 14, 2011

Related U.S. Application Data
(60) Provisional application No. 61/383,338, filed on Sep. 16, 2010.

(51) Int. Cl. G06F 3/041; G06F 3/042

(52) U.S. Cl. 345/173; 345/175

(57) ABSTRACT

A touch display device includes a main body, a detecting module and a touch display module. The detecting module includes a plurality of sensing elements for sensing a touch position of a user at the main body and providing a touch signal to the detecting module. The touch display module is disposed at the main body and electrically connected to the detecting module. The touch display device generates a function control zone corresponding to the touch position in accordance with the touch signal. A control method of a touch display device is disclosed as well. The touch display device and the control method can generate the function control zone corresponding to the touch position by sensing the touch of the user to replace physical hot keys.

### CROSS REFERENCE TO RELATED APPLICATIONS

The application claims priority to U.S. provisional patent application with Ser. No. 61/383,338 filed on Sep. 16, 2010. This and all other extrinsic materials discussed herein are incorporated by reference in their entirety.

### BACKGROUND OF THE INVENTION

1. Field of Invention

The disclosure relates to an electronic device and, more particularly, to a touch display device and a control method thereof.

2. Related Art

Although a touch display device becomes lighter, smaller and thinner, some physical hot keys, such as a power button, page-up and page-down keys, a volume button and a home button, are still necessary for intuitive operation. When the touch display device is rotated from an upright mode to a horizontal mode according to the requirement, although the content can be automatically adjusted to be displayed in the horizontal mode, the positions of the hot keys with physical functions for the upright mode cannot be adjusted accordingly. It easily causes the disorientation for users and results in operation errors.

### SUMMARY OF THE INVENTION

With a touch display device and a control method disclosed herein, the conventional fixed physical hot keys can be replaced. When the touch display device disclosed herein is rotated, the touch event of the user is detected by a detecting module to correspondingly adjust and reset a function control zone. Consequently, the user does not need to comply with the fixed physical hot keys of various devices, but the devices automatically adapt the function control zone to the user instead, so as to avoid disorientation and operation errors, and improve efficiency and comfort feeling in usage.

A touch display device includes a main body, a detecting module and a touch display module. The detecting module includes a plurality of sensing elements to sense a position of a touch event at the main body and provide a touch signal to the detecting module. The touch display module is disposed at the main body and electrically connected to the detecting module. The touch display device generates a function control zone corresponding to the touch position in accordance with the touch signal.

A control method of the touch display device is further provided. The touch display device includes a main body, a detecting module and a touch display module. The detecting module includes a plurality of sensing elements. The touch display module is disposed at the main body and electrically connected to the detecting module.

The control method includes following steps: sensing a touch position of the user at the main body via the sensing elements; generating a touch signal to the detecting module; and generating a function control zone by the touch display device corresponding to the touch position in accordance with the touch signal.

These and other features, aspects and advantages of the present disclosure will become better understood with regard to the following description, appended claims, and accompanying drawings.

### BRIEF DESCRIPTION OF THE DRAWINGS

FIG. 1A is a schematic diagram showing a touch display device in an embodiment;

FIG. 1B is a block diagram showing the touch display device in FIG. 1A;

FIG. 2A is a partial exploded diagram showing the touch display device in FIG. 1A;

FIG. 2B to FIG. 2C are schematic diagrams showing variations of the touch display device in FIG. 2A;

FIG. 3A is a schematic diagram showing that the touch display device senses a touch event of a user in an embodiment;

FIG. 3B is a partial enlarged view showing a touch position at the touch display device in FIG. 3A;

FIG. 3C is a schematic diagram showing that the user inputs a touch event at a contact area in FIG. 3B;

FIG. 3D is schematic diagram showing another variation of the touch display device in FIG. 3C;

FIG. 4 is a schematic diagram showing the touch display device in FIG. 3A whose operating direction is changed;

FIG. 5 is a schematic diagram showing a variation of the touch display device in FIG. 3B;

FIG. 6 is a schematic diagram showing a touch display device supported by a user in another embodiment; and

FIG. 7 is a flow chart showing steps of a control method of the touch display device in an embodiment.

### DETAILED DESCRIPTION OF THE INVENTION

A touch display device and a control method thereof in embodiments are illustrated with relating figures, and the same symbols denote the same components.

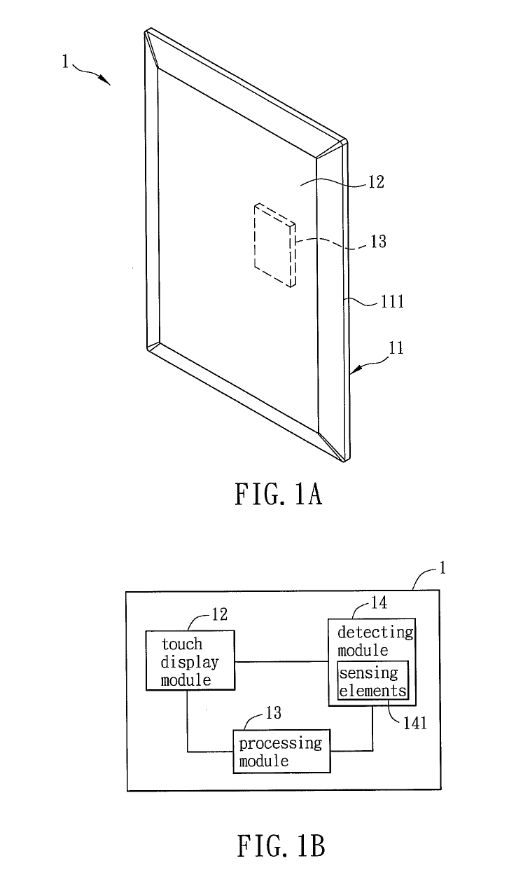

FIG. 1A is a schematic diagram showing a touch display device in an embodiment. FIG. 1B is a block diagram showing the system of the touch display device in FIG. 1A. The touch display device 1 may be a smart phone, a personal digital assistant (PDA), a tablet PC or a navigation device with global position system (GPS) function, which is not limited herein. In the embodiment, the touch display device 1 is a tablet PC.

The touch display device 1 includes a main body 11 and a touch display module 12 disposed at one side of the main body 11. The main body 11 includes a casing 111 covering components therein. The touch display module 12 provides the function of touching control and display. The casing 111 may cover the main body 11 to form a frame as shown in FIG. 1A, or without the frame, which is not limited herein.

As shown in FIG. 1B, the touch display device 1 further includes a processing module 13 and a detecting module 14, and the processing module 13 is disposed in the casing 111 of the main body 11.

The detecting module 14 includes a plurality of sensing elements 141 electrically connected to the processing module 13 and the touch display module 12. In one embodiment, the sensing elements 141 are disposed around or at the back of the main body 11 for detecting a touch position at the main body 11. The sensing elements 141 may be one or a combination of touch sensors, pressure sensors, temperature sensors and light sensors, which is not limited herein.

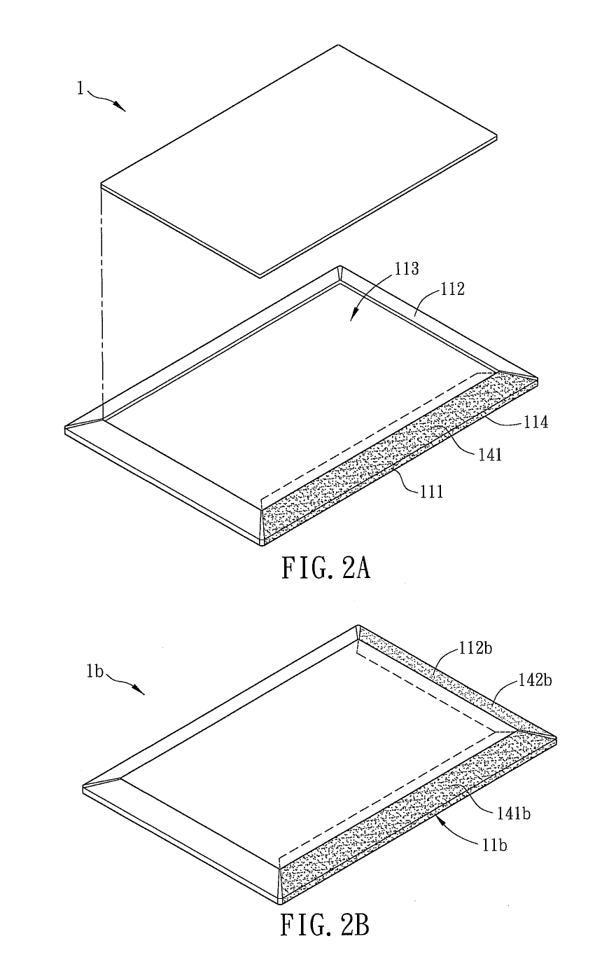

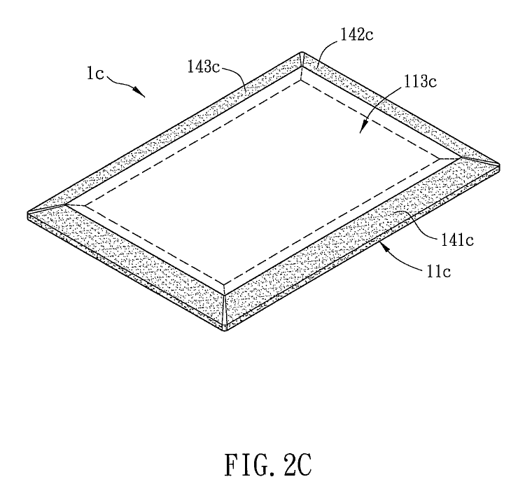

FIG. 2A is a partial exploded diagram showing the touch display device in FIG. 1A, and FIG. 2B to FIG. 2C are schematic diagrams showing variations of the touch display device in FIG. 2A.

To show the position of the detecting module 14 more clearly, as shown in FIG. 2A, the touch display module 12 of the touch display device 1 is separated from the main body 11, and an accommodation recess 113 is disposed at a front side 112 of the position where the touch display module 12 is disposed. However, the accommodation recess 113 formed to accommodate the display module 12 as disclosed herein is just for an example, it is to be understood, the configuration of a touch display device can be various, includes no physical edge portion or no frame of the display module 12 is also included in the disclosure.

The sensing elements 141 may be disposed around the accommodation space 113, such as at any position of the casing 111 as shown in FIG. 2A, or disposed at a back side 114 of the main body 11, which is not limited herein. The sensing elements 141 are used for detecting the touch area from fingers or hands. Generally, the fingers or hands contacting areas at the front side 112 and the back side 114 of the main body 11 are different, and the disposition of the sensing elements 141 can be various. For example, the disposition can base on possible patterns on the touch display device 1 when the user holds the main body 11 or any practical requirements of the user, which is not limited herein.

FIG. 2B is a schematic diagram showing a variation of the touch display device 1 in FIG. 2A. The components of the touch display device 1b are similar to that of the touch display device 1, and one difference is that two sensing elements 141b and 142b are disposed at two sides of the main body 11b. As a result, the sensing elements 141b and 142b can be used for sensing the touch event regardless in an upright mode or a horizontal mode.

FIG. 2C is a schematic diagram showing another variation of the touch display device 1 in FIG. 2A. In the embodiment, the sensing elements 141c to 144c are disposed at four sides around the main body 11c. Therefore, no matter how the user rotates the touch display device 1c, the sensing elements 141c to 144c can sense the touch event at the periphery and provide a touch signal to the detecting module.

The user usually operates the touch display device by holding, grasping or supporting, and the sensing elements 141 at the back side 114, at periphery, or at the casing 111 of the main body 11 can sense the touch event in different using modes.

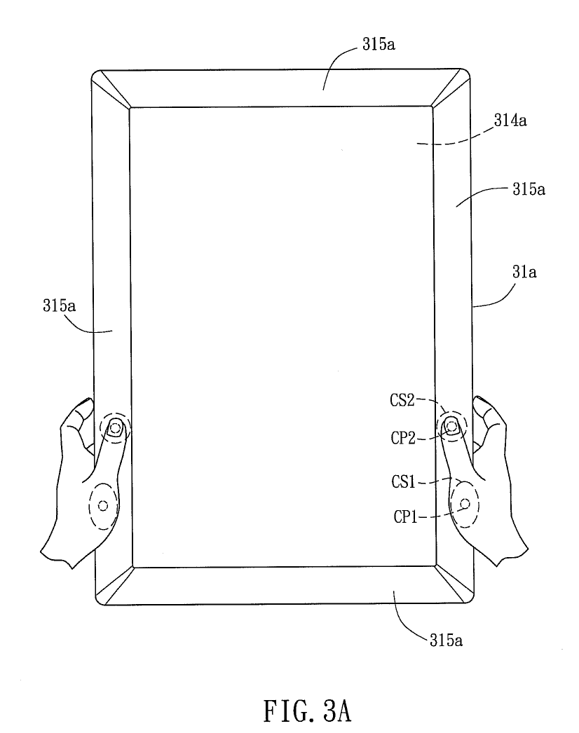

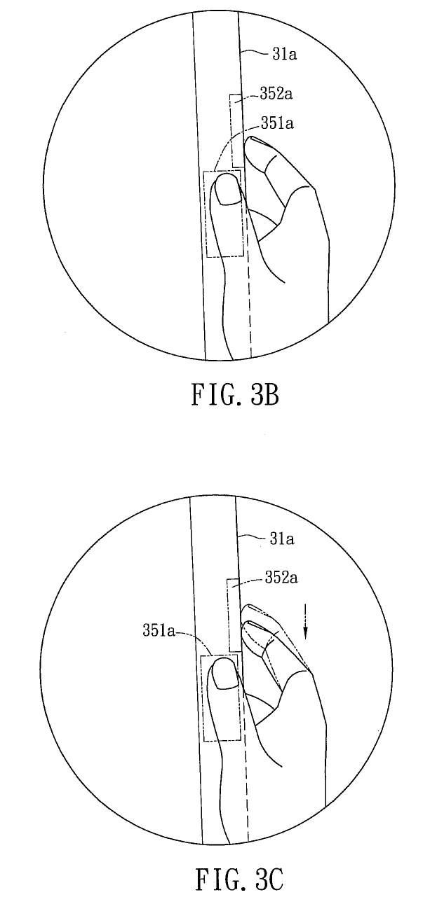

FIG. 3A is a schematic diagram showing that the touch display device senses a touch event of the user in an embodiment. FIG. 3B is a partial enlarged view showing the touch position of the user at the touch display device in FIG. 3A. The sensing elements are disposed at the periphery 315a and the back side 314a of the main body 31a. Therefore, regardless of the gestures is different in operating the touch display device, such as holding, grasping or supporting, the sensing elements can sense the touch event of the user.

The touch position at the main body sensed by the sensing elements is not limited to specific positions. For example, as shown in FIG. 3A, the sensing elements sense the touch position CP and the contact shape CS of the hands at the main body 31a.

The touch position CP may be a point, an area, multiple points or multiple areas at the main body 31a when the user touches. The contact shape CS may be an outline of a touch position or outlines of multiple touch positions respectively at the main body 31a.

In the embodiment, after the sensing elements sense a touch position CP1 and a contact shape CS1 of the thenar eminence and a touch position CP2 and a contact shape CS2 of the thumb, the sensing elements provides the touch signal to the detecting module. The processing module generates a function control zone at the touch position CP1 and CP2 and nearby or at an opposite side for the user to touch according to a signal from the detecting module. The sensing elements also may sense the contact area of the user.

As shown in FIG. 3B, three function control zones are formed. The function control zone 351a is formed at the touch position CP1. The function control zone 352a is formed around the touch position CP1, that is, at a side surface of the main body 31a. The third function control zone is formed at the opposite side of the touch position CP1, that is, the back of the main body 31a.

It is not limited to three function control zones, and one, two or more function control zones also may be formed. For example, a function control zone not only may be correspondingly formed at the touch display module independently, but also may be correspondingly formed at the touch display module simultaneously to avoid that the finger already touches the function control zone when the sensing elements sense a touch event.

The distance between the function control zone and the touch position, the size and the shape of the function control zone are not limited. The function control zone can be formed in any size or any shape as shown in FIG. 3B. In the embodiment, the function control zone corresponds to the touch position of hands or fingers.

When the user touches the position at the main body where the sensing elements are disposed, the touch display device generates the function control zone corresponding to the touch position for the user to control, and thus the physical hot keys are not needed.

FIG. 3C is a schematic diagram showing a condition that the user inputs a touch event at a contact area in FIG. 3B. When the user inputs a touch event by a downward single-touch sliding, and the processing module executes corresponding function such as scrolling a displayed page downward. The input of the touch event is not limited to the single-touch sliding, and it may be a clicking, pressing, multi-touch moving inwards or outwards, which is not limited herein. The control function is also not limited to displayed page scrolling down, and it may be the functions such as the power switch, page-up and page-down, volume adjustment or back home.

FIG. 3D is a schematic diagram showing another disposition aspect of the sensing elements of the touch display device in FIG. 3C. The disposition of the sensing elements is the same as that in the above embodiment. The touch display device not only generates the function control zones 351d and 352d but also distinguishes the touches of thenar eminences and different fingers to define a function control unit at the function control zone by technologies such as multi-detection. As shown in FIG. 3D, two function control units FU1 and FU2 are defined at the touch position of the thumb, and another two function control units FU3 and FU4 are defined at the touch position of the forefinger.

The touch display device not only generates the function control zones 351d and 352d according to the touch event, but also can defines the function control units FU1 to FU4 at appropriate positions to facilitate operation according to hand characteristics and different holding habits. The function control units FU1 to FU4 can used to control power consuming, displayed page up and down, volume adjustment or back home, which is not limited herein.

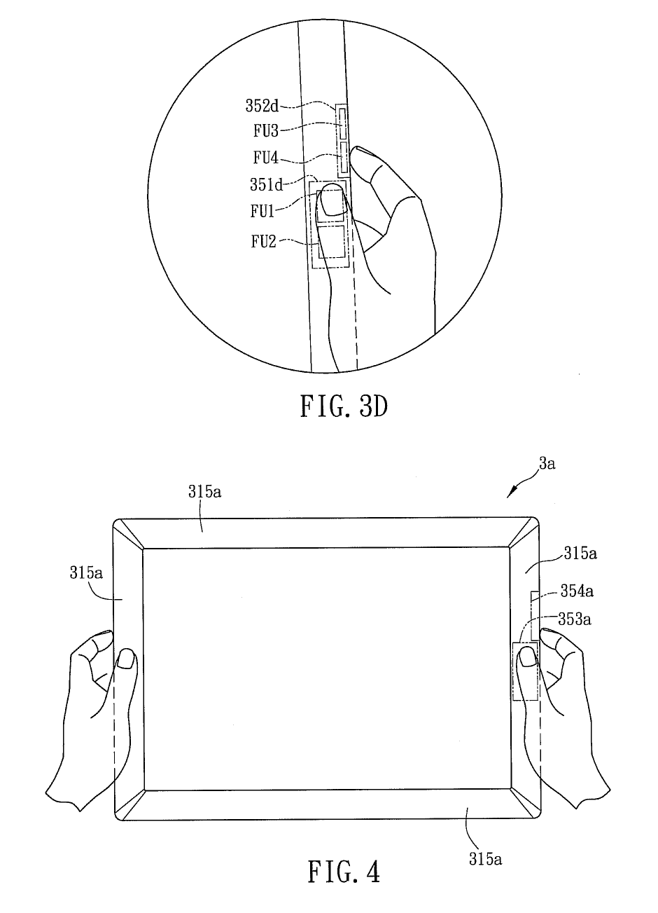

FIG. 4 is a schematic diagram showing the touch display device in FIG. 3A whose operating direction is changed by the user. As shown in FIG. 4, when the upright operation mode is changed to the horizontal operation mode, the user would hold or grasp the touch display device 3a upward or downward instead of the left side and the right side.

The sensing elements can sense a touch event instantly and the touch display device 3a will generate new function control zones 353a and 354a. Thus, the user does not need to look for target icons or recall memories of the various positions to find the physical hot keys, and further to instantly and intuitively operate the touch display device 3a. Thus the disorientation and operation errors are reduced.

When the sensing elements are disposed at the periphery 315a, no matter where the user holds or grasps at any position around the touch display device, the function control zone can be formed. Even the touch positions of two hands at the main body are not at the same level of height, such as one touch position is higher or lower than the other, the function control zone can be formed at the touch position, nearby, or at the opposite side of the touch position.

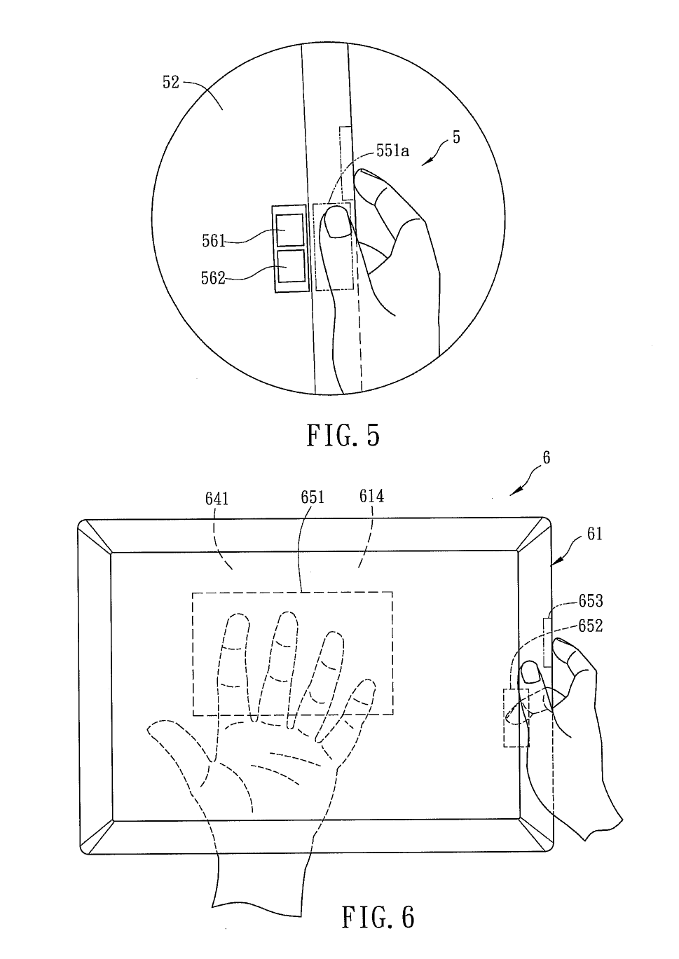

FIG. 5 is a schematic diagram showing a variation of the touch display device in FIG. 3B. In FIG. 5, most of all are similar to that in FIG. 3B. One difference is that an auxiliary control unit is displayed at the touch display module 52 corresponding to the function control zone 551a after the sensing elements sense the touch event of the user.

In the embodiment, the touch display module 52 displays two auxiliary control units 561 and 562 corresponding to the function control zone 551a for visual auxiliary to help the user to touch easily and precisely. It is to be understood, the displayed auxiliary control units 561 and 562 at the touch display module 52 disclosed in this embodiment includes visual image functions only, they're not the same as it is disclosed in previous embodiment that the function control zone generated at the touch display module 52 is for receiving touch events to execute corresponding functions.

However, according to the concept above, additional display module also may be disposed in the periphery to directly display the auxiliary control unit at the same position. Furthermore, since the touch display module includes touch detection function and image display function, the touch display module of the touch display device can be extended to the edge or even the back side of the main body to achieve both visual and touch detecting functions. FIG. 6 is a schematic diagram showing the touch display device is handled by a user in an embodiment. As showed in FIG. 6, most elements and configurations of the touch display device 6 is similar to that of the touch display device in the above embodiment. In the embodiment, a sensing element 641 is disposed at the back side 614 of the main body 61. Consequently, when the user handles and supports the touch display device 6, the touch display device 6 can generate the function control zone 651 at the touch position of hand. Additionally, although the user supports the touch display device with left hand, the function control zones 652 and 653 also may be formed at the back of the right side or the periphery of the main body 61, which is not limited herein.

A control method of a touch display device is also provided herein. The touch display device applying the control method includes a main body, a detecting module and a touch display module. The detecting module includes a plurality of sensing elements. The touch display module is disposed at the main body and electrically connected to the detecting module. The component structures and technology features are the same as that of the touch display device in the embodiments above, which is omitted herein.

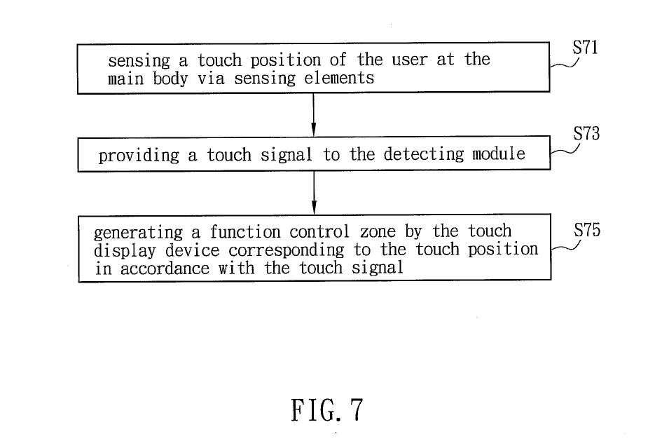

FIG. 7 is a flow chart showing steps of the control method of the touch display device in an embodiment. The control method includes the following steps: sensing a touch position at the main body via the sensing elements (S71); providing a touch signal to the detecting module (S73); and generating a function control zone by the touch display device corresponding to the touch position in accordance with the touch signal (S75).

In sum, a touch display device and a control method disclosed herein detect a touch position (or a touch position and a contact shape of a hand in holding) of the user at a main body via a detecting module and sensing elements, even after the main body is rotated, and a function control zone is generated correspondingly to receive a touch event. Different function control units can be further defined according to different fingers to form an operation interface. Consequently, the touch display device can spontaneously adapt to different holding ways of the user, and it can improve the convenience without looking for physical hot keys around the main body and avoid disorientation or operation errors.

Conventionally, the positions of physical hot keys are fixed to facilitate learning and memorizing the operations in a fixed operation direction. However, since the locations of the hot keys cannot be adjusted along with displayed content synchronously, the operation habits limited by hardware would become a main reason of recognition difficulty and operation errors after the rotation of the touch display device. In contrast, with the touch display device and the control method thereof in the embodiment, the conventional physical hot keys can be replaced. Furthermore, the position of the function control unit can be defined according to hand characteristics of different users, so as to improve efficiency and comfort feeling in usage.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A touch display device comprising:
a main body;
a detecting module including a plurality of sensing elements to sense a touch position at the main body and generate a touch signal to the detecting module; and
a touch display module disposed at the main body and electrically connected to the detecting module,
wherein the touch display device generates a function control zone corresponding to the touch position in accordance with the touch signal.

2. The touch display device according to claim 1, wherein the main body has a periphery surrounding the touch display module, and the sensing elements are disposed at the periphery.

3. The touch display device according to claim 1, wherein the sensing elements are touch sensors, pressure sensors, temperature sensors, light sensors or the combination thereof.

4. The touch display device according to claim 1, wherein the sensing elements senses a contact area or a contact shape at the main body.

5. The touch display device according to claim 1, wherein the function control zone is at the touch position, around the touch position or at an opposite side of the touch position.

6. The touch display device according to claim 1, wherein the function control zone has a function control unit.

7. The touch display device according to claim 1, wherein the touch display module displays an auxiliary control unit corresponding to the function control zone.

8. A control method of a touch display device, wherein the touch display device includes a main body, a detecting module and a touch display module, the detecting module includes a plurality of sensing elements, the touch display module is disposed at the main body and electrically connected to the detecting module, the control method comprising following steps:
sensing a touch position at the main body via the sensing elements;
generating a touch signal to the detecting module; and
generating a function control zone by the touch display device corresponding to the touch position in accordance with the touch signal.

9. The control method according to claim 8, wherein the main body has a periphery surrounding the touch display module, and the sensing elements are disposed at the periphery.

10. The control method according to claim 8, wherein the sensing elements are touch sensors, pressure sensors, temperature sensors, light sensors and the combination thereof.

11. The control method according to claim 8, wherein the sensing elements sense a contact shape at the main body.

12. The control method according to claim 8, wherein the function control zone is at the touch position, around the touch position or at an opposite side of the touch position.

13. The control method according to claim 8, wherein the function control zone has a function control unit.

14. The control method according to claim 8, wherein generating the function control zone includes displaying an auxiliary control unit corresponding to the function control zone at the touch display module.
